(19) United States
(12) Patent Application Publication
(10) Pub. No.: US 2026/0152447 A1
(43) Pub. Date: Jun. 4, 2026

(54) MULTI-LAYER PROTECTIVE COATING SYSTEMS, METHODS OF MAKING, AND ARTICLES OF MANUFACTURE PROVIDED THEREWITH

(71) Applicant: Purdue Research Foundation, West Lafayette, IN (US)

(72) Inventors: Abdullah Al Saad, Dubuque, IA (US); Rodney Wayne Trice, Xenia, OH (US); Carlos Javier Martinez, West Lafayette, IN (US)

(21) Appl. No.: 18/890,359

(22) Filed: Sep. 19, 2024

Related U.S. Application Data
(60) Provisional application No. 63/542,080, filed on Oct. 2, 2023.

(51) Int. Cl. C04B 41/52; C04B 35/83; C04B 41/45; C04B 41/50; C04B 41/87; C04B 41/89

(52) U.S. Cl. CPC C04B 41/52; C04B 35/83; C04B 41/4533; C04B 41/5042; C04B 41/5045; C04B 41/5059; C04B 41/507; C04B 41/87; C04B 41/89; C04B 2235/422; C04B 2235/5248

(57) ABSTRACT

Multi-layer protective coating systems, methods of making such coatings, and articles of manufacture provided with such coatings. Such a coating system has a SiC layer overlying a surface of a carbon-fiber reinforced carbon matrix (C/C) composite, a ZrB₂—SiC layer overlying the SiC layer, a ZrC—ZrO₂ layer overlying the ZrB₂—SiC layer, and a Sm₂O₃—ZrO₂ layer overlying the ZrB₂—SiC layer and preferably serving as a topcoat of the coating system. The coating system is capable of serving as an ablation and oxidation protection measure for C/C composites, for example, as may be experienced at the leading edge(s) of a hypersonic aeronautical vehicle while moving through the earth's atmosphere.

### CROSS-REFERENCE TO RELATED APPLICATIONS

This application claims the benefit of provisional U.S. Patent Application No. 63/542,080 filed Oct. 2, 2023, the contents of which are incorporated herein by reference.

### STATEMENT REGARDING FEDERALLY SPONSORED RESEARCH

This invention was made with government support under Contract No. N00014-20-1-2262 awarded by the Office of the Naval Research. The government has certain rights in the invention.

### BACKGROUND OF THE INVENTION

The invention relates generally to coatings that may be used for protecting carbon-fiber reinforced carbon matrix (C/C) composites, associated methods of making such coatings, and articles of manufacture provided with such coatings.

During re-entry into the earth's atmosphere from outer space, the hypersonic leading edges of aerospace vehicles can experience enormous heat fluxes, for example, with surface temperatures rising to greater than 1600° C. expected. Carbon-fiber reinforced carbon matrix composites, hereinafter referred to as C/C composites (or simply C/C), are popular thermal protection system materials because of their high strength at elevated temperatures up to 2000° C. However, C/C composites are prone to ablation damage at their surfaces if unprotected in an oxidizing atmosphere at temperatures above 500° C. This problem has been typically addressed by either modifying the carbon matrix of a CC composite with ultra-high temperature ceramics (UHTC) or applying UHTC coatings on the exposed side of a C/C composite substrate. Such approaches, however, are only partly effective because conventionally-used UHTCs are also subject to oxidation at temperatures above 1200° C. In addition, these approaches have disadvantages including manufacturing complexity and high cost.

Therefore, it would be desirable to have an ablation-resistant coating that can protect C/C composite substrates at higher temperatures, e.g., above 1200° C., that are simpler to fabricate and/or more cost-effective than methods using conventional UHTC admixtures and/or coatings. In some circumstances, it would also be desirable for such ablation-resistant coating to possess high IR (infrared) emissivity.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, multi-layer protective coating systems, articles of manufacture having multi-layer protective coating systems, and methods of making multi-layer protective coating system on a substrate.

According to a nonlimiting aspect, a multi-layer protective coating system for a substrate includes a first layer having silicon carbide (SiC) disposed on the substrate, a second layer having zirconium diboride-silicon carbide (ZrB₂—SiC) disposed on the first layer, a third layer having zirconium carbide-zirconium oxide (ZrC—ZrO₂) disposed on the second layer, and a fourth layer having samaria-modified zirconium oxide (Sm₂O₃—ZrO₂) disposed on the third layer.

According to another nonlimiting aspect, an article of manufacture includes a substrate made of carbon-fiber reinforced carbon matrix (C/C) composite and a multi-layer protective coating system disposed on a surface of the substrate. The protective coating system includes a first layer containing silicon carbide (SiC) disposed on a surface of the substate, a second layer containing zirconium diboride-silicon carbide (ZrB₂—SiC) disposed on the first layer, a third layer containing zirconium carbide-zirconium oxide (ZrC—ZrO₂) disposed on the second layer, and a fourth layer containing samaria-modified zirconium oxide (Sm₂O₃—ZrO₂) disposed on the third layer.

According to still another nonlimiting aspect, a method of making a multi-layer protective coating system on a substrate to be protected includes providing the substrate with a first layer comprising silicon carbide (SiC) on an exterior surface of the substrate, applying a second layer containing zirconium diboride-silicon carbide (ZrB₂—SiC) on the first layer, applying a third layer containing zirconium carbide-zirconium oxide (ZrC—ZrO₂) on the second layer, and applying a fourth layer containing samaria-modified zirconium oxide (Sm₂O₃—ZrO₂) on the third layer.

Technical aspects of multi-layer protective coating systems as described above preferably include the ability to protect a substrate, such as a C/C composite substrate, from ablation while moving at hypersonic speeds through the atmosphere.

These and other aspects, arrangements, features, and/or technical effects will become apparent upon detailed inspection of the figures and the following description.

### BRIEF DESCRIPTION OF THE DRAWINGS

FIG. 1 is a schematic cross-sectional diagram of an article of manufacture having a multi-layer protective coating system disposed on a substrate to be protected in accordance with certain non-limiting aspects of the invention.

FIG. 2 illustrates steps in a method of applying the multi-layer coating of FIG. 1 to the substrate according to other non-limiting aspects of the invention.

FIG. 3 illustrates steps in a method of applying a first layer of the multi-layer coating to the substrate before applying additional layers of the multi-layer coating according to further non-limiting aspects of the invention.

FIG. 4 contains scanning electron microscope (SEM) micrograph scans of spray-dried feed powders from different batches of powders used in investigations leading to the invention.

FIG. 5 shows energy dispersive spectroscopy (EDS) map scans on a cross-section of a pack-cemented SiC layer on a C/C substrate.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of the embodiment(s) to which the drawings relate. The following detailed description also describes certain investigations relating to the embodiment(s), and identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

The following describes multi-layer protective coating systems in reference to their use to protect C/C composites, though it will be appreciated that the teachings of the invention are also generally applicable to use of such coatings with other types of substrates, such as but not limited to, other types of materials and/or substrates that are subject to high temperatures and ablation damage therefrom. Such other materials and substrates may be other types of materials used, for example, for the leading edges of hypersonic aeronautical vehicles or other surfaces subject to hypersonic forces in the earth's atmosphere, as well as other materials and/or substrates that would be subject to high temperatures and ablation damage.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

The multi-layer protective coating systems (or more simply, protective coating system(s) or coating system(s)) are made up of individual layers formed of borides, carbides, zirconia, and/or rare-earth oxides as emissivity modifiers, can be applied to a surface of a C/C composite substrate, and preferably capable of providing ablation and oxidation protection to C/C composites, among other uses. Such a coating system contains layers of SiC, ZrB₂—SiC (ZBS), and ZrC—ZrO₂ (ZZC) that are sometimes referred to herein as sublayers, which are overlaid by a Sm₂O₃—ZrO₂ (SZC) layer that is sometimes referred to herein as a topcoat that serves as the outermost layer of the coating system. In investigations leading to the present invention, a SiC sublayer can was directly deposited onto a C/C substrate using a pack cementation technique, while ZBS, ZZC, and SZC sublayers were applied using plasma spray technology. The as-sprayed coating system layers exhibited well-defined adhesion therebetween and to the substrate without forming major voids or cracks. To evaluate efficacy in preventing oxidation and ablation, samples of the coating system were exposed to a high heat flux oxyacetylene torch with a maximum heat flux reaching up to 390 W/cm². It was observed that coating systems with individual layer thicknesses of about 100 μm demonstrated excellent ablation, oxidation, and mass erosion resistance as they reduced the mass ablation rate of C/C by about 90% at a maximum surface temperature of about 2100° C. The ablated multilayer coating system exhibited a dense topcoat that effectively acted as a barrier against heat and oxygen. The ZBS and ZZC sublayers remained physically and chemically unaffected and maintained their integrity throughout the high heat flux ablation testing period. The spectral emittance of the topcoat, SZC, was measured in the IR spectrum at high temperatures up to 1200° C. to have a maximum spectral emissivity of 0.99 at λ=12.5 μm, evidencing that the multi-layer protective coating system has a high emittance with improved thermal radiation efficiency that can be beneficial for hypersonic reentry application, by way of non-limiting example. The layers may be applied via one or more pack cementation processes, shrouded plasma spray processes, and plasma spray processes.

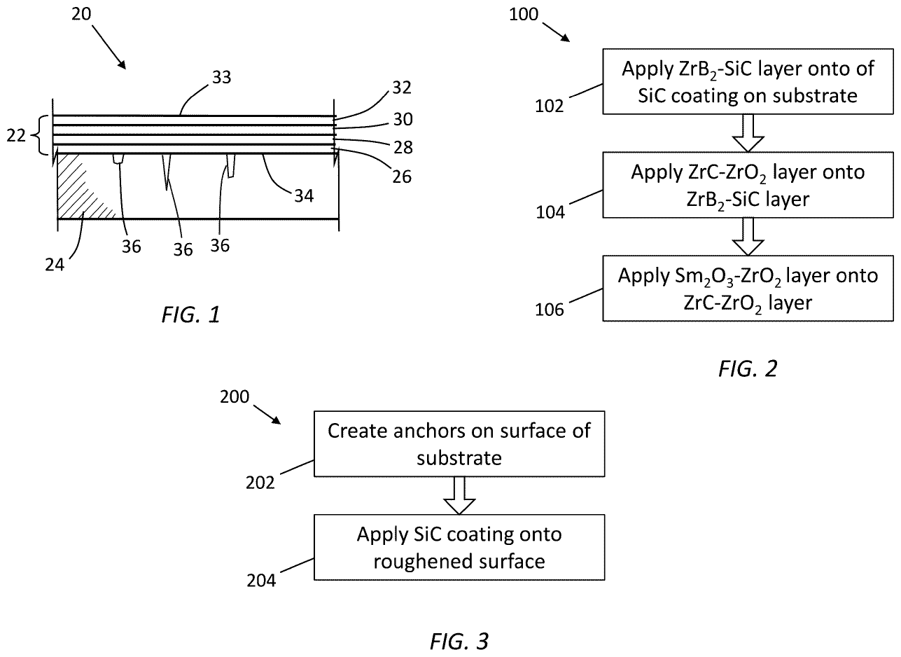

An exemplary multi-layer protective coating system 22 is schematically represented in FIG. 1 as comprising four layers 26, 28, 30, and 30 on a surface 34 of a substrate 24, yielding an article of manufacture 20. In this example, the substrate 24 is made of a C/C composite. The substrate 24 may form or be part of any desired structure, component, machine, etc. In some configurations, the article of manufacture 20 may be part of an aeronautical vehicle, such as a hypersonic aircraft, missile, or space craft. For example, the substrate 24 may be disposed at a surface of an aeronautical vehicle that is subject to high temperatures above 1200° C. due to fluid flow of air across the substrate 24, such the leading edge of a component of a hypersonic aeronautical vehicle. Some such leading edges may be, for example, the leading edge of a wing, a stabilizer, a nose, a fuselage, and/or an engine shroud. However, the protective coating system 22 is not limited to use on C/C composites on a particular article of manufacture 20 expressly described herein, but rather, may be used as a protective coating system for any material and/or article of manufacture suitable to receive the protective coating system.

The four separate layers 26, 28, 30, and 32 represented in FIG. 1 include a first layer 26 (sometimes referred to herein as the SiC layer or “layer 1”) that contains silicon carbide (SiC) and is disposed on and directly contacts the surface 34 of the substrate 24, a second layer 28 (sometimes referred to herein as the ZBS layer or “layer 2”) that contains zirconium diboride-silicon carbide (ZrB₂—SiC) and is disposed on and directly contacts the outer surface of the first layer 26, a third layer 30 (sometimes referred to herein as the ZZC layer or “layer 3”) that contains zirconium carbide-zirconium oxide (ZrC—ZrO₂) and is disposed on and directly contacts the outer surface of the second layer 28, and a fourth layer 32 (sometimes referred to herein as the SZC layer or “layer 4”) that contains samaria-modified zirconium oxide (Sm₂O₃—ZrO₂) and is disposed on and directly contacts the outer surface of the third layer 30. Typically, although not necessarily, the fourth layer 32 is the topcoat (outermost layer) of the protective coating system 22 whose outer surface 33 defines the outermost surface of the coating system 22 (and therefore the article of manufacture 20) that, for example, may be subject to high temperatures caused from surface friction of hypersonic fluid flow of air and/or other gases against the outer surface 33 of the fourth layer 32. However, additional coatings or other coverings could be disposed on the outer surface 33 of the fourth layer 32. In this example arrangement, the second layer 28 and the third layer 30 may provide intermediate coefficient of thermal expansion (CTE) values in a range of 7-8 ppm/° C. and bridge the gap in thermal expansion between the outermost layer (the fourth layer 32) and the substrate 24. Furthermore, the stabilized zirconia of the fourth layer 32 can act as a barrier for reducing the diffusion of oxygen species into the coating system 22, which can improve the oxidation prevention mechanism of the ZrB₂—SiC of the second layer 28. Rare-earth dopants, such as Sm³⁺, Yb³⁺, Er³⁺, can also provide the capability to modify the emissivity of the coating system 22. The third layer 30 can function as a CTE and diffusion buffer between the second layer 28 and the fourth layer 32. In other embodiments, it is foreseeable that additional layers of materials could be disposed on any one or more of the layers 26, 28, 30, and 32.

Referring now to FIGS. 2 and 3, the multi-layer protective coating system 22 may be applied to the substrate 24 with multiple separate coating application processes, one application process for each of the layers 26, 28, 30, and 32 of the protective coating system 22. FIG. 2 illustrates a method 100 of applying the multi-layer protective coating system 22, in which the substrate 24 has already been coated with the SiC (first) layer 26, such as from a commercial source. In this example, because the substrate 24 has been provided with the first layer 26 already in place on the surface 34 of the substrate, at 102, the ZBS (second) layer 28 is applied onto the outer surface of the first layer 26, at 104, the ZZC (third) layer 30 is applied onto the outer surface of the second layer 28, and at 106, the SZC (fourth) layer 32 is applied onto the outer surface of the third layer 30. Optionally, for example if the substrate 24 is not provided with the first layer 26 already coated onto its surface, the method 100 may also include a step of applying the first layer 26 to the surface 34 of the substrate 24 before the second layer 28 is applied. FIG. 3 illustrates one possible method 200 of applying the first layer 26. In the method 200, at 202, anchors 36 are created on the surface 34 of the substrate 24 to provide for improved mechanical adhesion of the first layer 26 to the surface 34 of the substrate 24. Typically, the anchors 36 are in the form of elongate channels recessed into the surface 34 of the substrate 24 (as represented in FIG. 1); although other shapes of the anchors 36 are possible. This anchoring process 202 may be accomplished, for example, by abrading the surface 34 and/or ablating the abraded surface 34. The abrading may be performed, for example, with a fine sandpaper. The ablating may be performed, for example, with a flame. However, other methods of creating the mechanical anchors may be used, or the step of creating anchors may be omitted entirely. Assuming that the anchoring step 202 was performed, at 204, the first layer 26 is then applied onto the roughened surface 34. The step 204 of applying may be performed, for example, by a pack cementation process. In some embodiments, the first layer 26 is applied by a pack cementation process, the second layer 28 is applied by a shrouded plasma spray process, the third layer 30 is applied by a shrouded plasma spray process, and the fourth layer 32 is applied by a plasma spray process. Applying the second and third layers 28 and 30 with the shrouded plasma spray process(es) allows the oxidation of borides and carbides to be controlled during the thermal spray process.

Advantageously, the multi-layer protective coating system 22 is preferably sustainable in a high heat flux atmosphere and is less prone to cracking with tailorable emissivity control than previously known UHTC coatings. The multi-layer protective coating system 22 can be applied on a variety of composite materials subject to hypersonic flow through earth's atmosphere, such as C/C composite components used on hypersonic aeronautic vehicles. In some configurations, the multi-layer protective coating system 22 can also protect the C/C composite substrate of the component from being oxidized in an oxygen-rich environment.

In the four-layer protective coating system 22 represented in FIG. 1, the SiC of the first layer 26 is a pack cemented layer on the C/C composite 24, the ZrB₂—SiC (ZBS) of the second layer 28 functions as a UHTC sublayer, the ZrC—ZrO₂ (ZZC) of the third layer 30 functions as an intermediate transition sublayer, and the Sm₂O₃—ZrO₂ (SZC) of the fourth layer 32 functions as a topcoat. The ZrB₂—SiC of the second layer 28 is a composite material that has generally demonstrated its effectiveness in inhibiting oxidation and ablation as both bulk material and coating material up to 1600° C. The ZrC—ZrO₂ of the third layer 30 functions to reduce the CTE mismatch between the SZC fourth layer 32 and the ZBS second layer 28. ZrC is an excellent UHTC with a very high melting point, and when doped with ZrO₂ at optimal concentrations it forms a mixture of ZrC, ZrO₂, and ZrCₓO_{y} upon fabrication. ZrO₂-doped ZrC coatings on C/C substrates demonstrated improved ablation resistance than ZrC itself, possibly due to a reduced C/Zr ratio and increased relative concentration of ZrCₓO_{y} in the coating. ZrCₓO_{y} is believed to reduce CO evolution and effectively minimize the deleterious effects of gaseous products on the coating system 22 during ablation. Therefore, it was concluded that the combination of ZrB₂—SiC stacked with ZrC—ZrO₂ increased the ablation resistance of the C/C substrate.

The topcoat (fourth layer 32) of Sm₂O₃-stabilized ZrO₂ acts as an oxygen and thermal barrier, and is believed to reduce the bulk temperature of the underlying UHTC layers (e.g., second and third layers 28 and 30) and the C/C substrate 24 through two mechanisms. First, Sm₂O₃—ZrO₂ has low thermal conductivity, limiting heat conduction from the fourth layer 32 to the sublayers 30, 28, and 26. Second, due to its high intrinsic emissivity, Sm₂O₃ is believed to act as an emissivity modifier for the ZrO₂ matrix and improve the IR emissivity of the ZrO₂ layer. It is believed that this allows the fourth layer 32, as the topcoat of the coating system 22, to radiate energy away from the outer surface 33 of the entire system 20 via thermal radiation and maintain a relatively lower surface temperature. In some embodiments, the Sm₂O₃—ZrO₂ fourth layer 32 has spectral emittance in a range of about 0.8 to about 0.99 at radiation wavelength in a wavelength range of about 7 to about 15 μm. In tests leading to the development of the multi-layer protective coating system 22, 6 mol % Sm₂O₃ was used to stabilize ZrO₂ upon plasma spray since it produced a non-transformable, non-equilibrium tetragonal t′-ZrO₂ phase. It has been demonstrated that a t′-ZrO₂ coating stabilized with 6 mol % Sm₂O₃ on SiC-coated-C/C substrates possess improved thermal shock resistance and ablation resistance as the coating reduced the mass ablation resistance by about 71% (1.92 mg/cm² to 0.55 mg/cm² s) after 60 s of ablation test at about 390 W/cm² constant heat flux. However, investigations show that the multi-layer protective coating system 22 can further improve the ablation resistance of the t′-ZrO₂ coating stabilized with 6 mol % Sm₂O₃ coating by reducing the mass ablation resistance even further.

Certain investigations leading to the development of the multi-layer protective coating systems 22 and the methods 100 and 200 are described below.

Circular C/C substrate specimens with about 21.6 mm diameter and about 5 mm thickness were selected as substrates. To minimize the mismatch of the coefficients of thermal expansion (CTE) between the C/C and ZBS layer, a thin interlocking transition layer of SiC (CTE about 4-5×10⁻⁶/m/° C.) was applied to the C/C surface via pack cementation. The C/C surface was prepared for pack cementation by abrading with 320 grit SiC paper and then pre-treated for 30 s using an oxyacetylene ablation torch. In this process, the surface roughness of C/C was increased from Sₐ=about 11.93 μm to about 21.64 μm. The pre-treated samples were washed in an ultrasonic bath for five minutes sequentially using deionized water and ethanol as solvents. The washed samples were then dried in an oven for about two hours at 135° C. Thereafter, the SiC layer 26 was applied to the anchored surface by a process of pack cementation, substantially as explained in further detail below.

To prepare a proper powder feedstock for shrouded and air plasma spray, the starting powders were mixed and spray-dried in three separate batches. The details of these three batches are described in Table 1, below.

TABLE 1
Spray-dried feed powder batches as feedstock for plasma spray

| | | | | | Particle Size, | |
|---|---|---|---|---|---|---|
| | | | | | D₅₀ (μm) | |
| | | Wt | Vol | | As- | Spray- |
| Batch | Powder | % | % | Supplier | purchased | dried |
| 1 | ZrB₂ | 82 | 71.7 | Hoganas | 1.5-3.0 | 43 |
| | SiC | 18 | 28.3 | Hoganas | 1.0-2.5 | |
| 2 | ZrC | 70 | 66 | Hoganas | 3.0-5.0 | 59 |
| | m-ZrO₂ | 30 | 34 | Inframet | 0.4-0.7 | |
| 3 | m-ZrO₂ | 85 | 88 | Inframet | 0.4-0.7 | 46 |
| | Sm₂O₃ | 15 | 12 | MSE Supplies | 0.1 | |

The powders were mixed in a slurry with a solid-to-liquid ratio shown in Table 2 using Darvan 821A as the dispersant and PVA (Celvol 203) as the binder. The dispersant and binder composition for each batch of powders were selected based on known properties. The target inlet was at 225-230° C., and the target outlet was at 105-110° C.

TABLE 2
Ingredient compositional ratio used in the spray drying process

| | Solid | DI water | Darvan | PVA |
|---|---|---|---|---|
| Batch | (wt %) | (wt %) | (wt %) | (wt %) |
| 1 | 50 | 48.5 | 0.5 | 1 |
| 2 | 48.9 | 49 | 0.9 | 1.9 |
| 3 | 53 | 45 | 0.2 | 1.8 |

The granulated batch 1 and batch 2 powders identified in Table 2 were deposited as coatings on a C/C substrate using shrouded plasma spray technology, and the batch 3 powders identified in Table 2 were applied using atmospheric plasma spray technology. The shroud torch was specifically designed to protect the UHTC materials (ZrB₂, SiC, and ZrC) from being oxidized during the plasma spray process. The plasma spray parameters are shown in Table 3, below.

TABLE 3
Plasma spray parameters for powder batches 1, 2, and 3.

| | Batch 1: | Batch 2: | Batch 3: |
|---|---|---|---|
| | ZrB₂—SiC | ZrC—ZrO₂ | Sm₂O₃—ZrO₂ |
| Torch | PST | PST | Cascaded |
| | Proprietary | Proprietary | Plasma |
| Torch Gas | Argon | Argon | Argon |
| Torch Gas Flow (SCFH*) | 180 | 180 | 120 |
| Secondary Gas | Hydrogen | Hydrogen | Hydrogen |
| Secondary Gas Flow | 40 | 20 | 15 |
| (SCFH) | | | |
| Shield Flow Gas | Nitrogen | Nitrogen | — |
| Shield Gas Flow (SCFH) | 2400 | 2400 | — |
| Amperage | 175 | 150 | 450 |
| Powder Feed Rate (g/min) | 20 | 20 | 50 |
| Spray Distance (inch) | 2.0 | 1.5 | 3.5 |

*SCFH = Standard cubic feet of gas per hour = 0.47 Liters per minute (L/min)

Two-, three-, and four-layer coatings were developed with various thicknesses. Table 4 lists the nomenclature and thickness of the plasma sprayed coatings discussed hereinafter. All of the coating systems listed in Table 4 had a pack cemented SiC layer of about 15-28 μm thick as the first layer 26 deposited on the surface of the C/C sample. The plasma sprayed layers were applied with a combination of three different target thickness values, for example, 50 μm, 100 μm, and 150 μm corresponding to the letters A, B, and C, in the coating nomenclature.

TABLE 4
nomenclature and thickness of plasma sprayed coatings

| | Nomenclature | | | |
|---|---|---|---|---|
| | (A = 50 μm, | | | |
| | B = 100 μm, | True layer thickness (μm) | | |
| | C = 150 μm, | | | Layer 4: |
| | from SiC layer | Layer 2: | Layer 3: | Sm₂O₃—ZrO₂ |
| Category | to surface) | ZrB₂—SiC | ZrC—ZrO₂ | (topcoat) |
| Two-layer | B | 97 | — | — |
| Three- | BB | 97 | 95 | — |
| layer | | | | |
| Four- | AAA | 46 | 56 | 56 |
| layer- A | AAB | 46 | 56 | 114 |
| series | AAC | 46 | 56 | 160 |
| Four- | BBA | 97 | 95 | 56 |
| layer- B | BBB | 97 | 95 | 114 |
| series | BBC | 97 | 95 | 160 |
| Four- | CCA | 150 | 142 | 56 |
| layer- C | CCB | 150 | 142 | 114 |
| series | CCC | 150 | 142 | 160 |

The room temperature clastic properties and CTE of ZrB₂—SiC, ZrC—ZrO₂, and Sm₂O₃—ZrO₂ composites are shown in Table 5, below.

TABLE 5
Thermophysical properties of the composite systems

| Composite | Bulk modulus, | Shear modulus, | CTE, α |
|---|---|---|---|
| (const.* 1 + const. 2) | B (GPa) | G (GPa) | (×10⁻⁶/° C.) |
| ZrB₂ + SiC | 217.88 | 204.83 | 6.23 |
| ZrC + ZrO₂ | 210.28 | 135.26 | 7.94 |
| Sm₂O₃ + ZrO₂ | 171.47 | 81.26 | 10^{⊥} |

*const. = constituent of a composite,
^{⊥}adopted based on the experimental value from reference

These values were calculated empirically based on the ambient condition properties of the bulk materials. The actual elastic moduli of the coated materials are believed to be significantly less than the ideal values due to the porosity and the lamellar microstructure.

High heat flux oxyacetylene torch testing was conducted using an oxyacetylene ablation torch rig to evaluate the ablation properties of plasma-sprayed multilayer coatings on C/C. The final ablation rates were obtained according to the following equation:

$${R}_{m} = \frac{{m}_{i} - {m}_{f}}{tA} ;$$

where Rₘ refers to the mass ablation rates, mᵢ and m_{f} are the sample masses before and after ablation, t is the ablation period, and A is the frontal surface area.

For phase identification, X-ray diffraction (XRD) was performed on spray-dried powders, as-sprayed coatings, and ablation-tested coatings using CuKα radiation with K−α1=1.5406 Å, K−α2=1.54443 Å and a K−α1/K−α2 ratio of ½. The scan ranged continuously between 2θ=20°-80° or 100° using a step size of 0.026° and a scan speed of 5°/minute. The generator was set at 40 mA, 45 kV, and no incident beam monochromator was used. Scanning electron microscopes equipped with an EDS detector (EDS working distance=10 mm) were utilized to study the topographical and cross-sectional micrographs. Thin layers of Pt were sputter coated prior to microscopic imaging because of the non-conductive nature of the specimens. The XRD showed that all three batches have constituent phases. The expected phases were observed in each batch of powders.

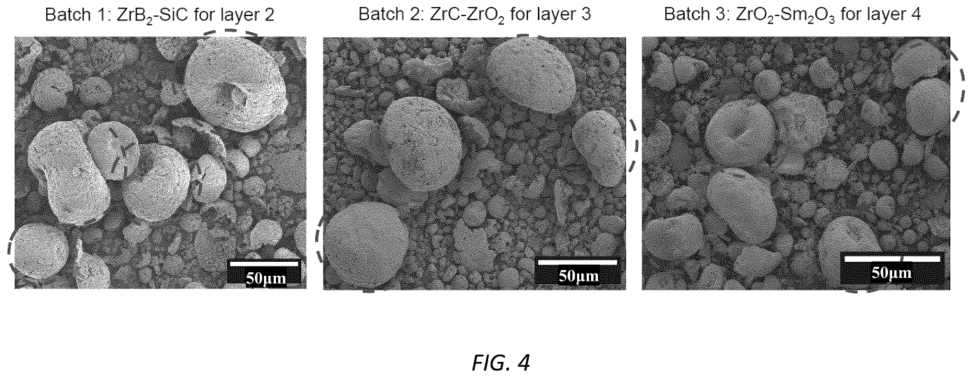

As seen in FIG. 4 the powders from batches 1 and 3 contained mostly toroidal particles, while the powders from batch 2 were predominantly spherical.

Because the Sm₂O₃—ZrO₂ layer is a high emittance topcoat, the spectral emittance of this material was measured at 900, 1000, 1100, and 1200° C. The detail description of the instrument setup and measurement methodology may be found in U.S. Pat. No. 5,239,488, the contents of which are incorporated by reference herein. The sample for this measurement was prepared by uniaxially cold pressing spray-dried batch 3 powder (6 mol % Sm₂O₃-94 mol % ZrO₂) and subsequently sintering at 1500° C. for 2 h in a benchtop MoSi₂ furnace.

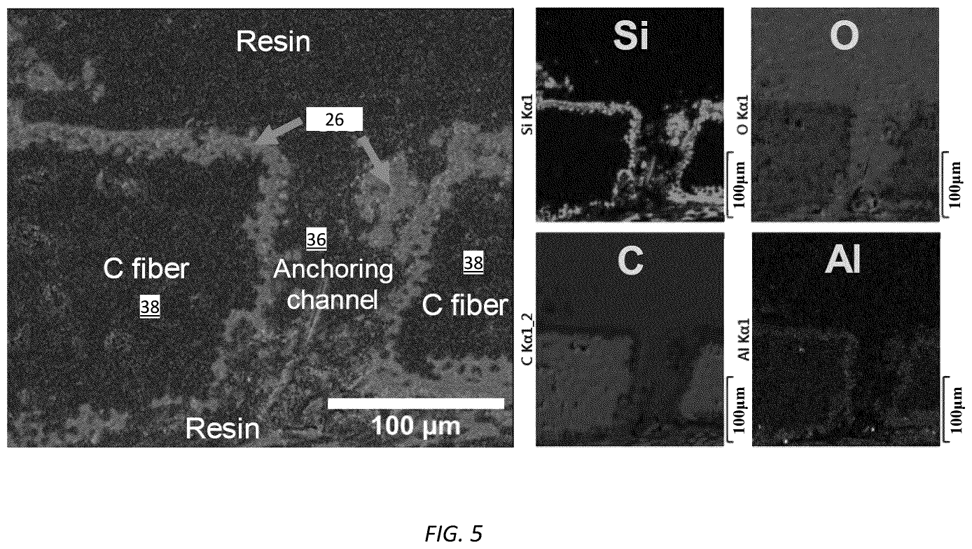

FIG. 5, shows the packed cemented SiC layer on the C/C substrate and anchoring channels 36 between two carbon fibers (“C fibers”) 38. The anchoring channels 36 are in the form of groove features between C fibers 38 that allowed improved infiltration of SiC particles inside the C/C bulk composite of the substrate 24. The anchoring channels 36 created by the pre-treatment step were beneficial in retaining the plasma-sprayed ceramic coatings on the surfaces of the C/C substrates. The SiC layer 26 penetrated into and/or in between the C/C fibers 38 through the anchoring channels 38. The presence of Si and C elements in the pack-cemented layer can be seen in the EDS map scans. In addition, aluminum (Al) was present due to the use of alumina (Al₂O₃) during packing cementation and oxygen (O) due to the use of resin during sample preparation for SEM.

XRD scans of as-sprayed B, BB, and BBB (B (two-layer), BB (three-layer), and BBB (four-layer) coatings suggested the occurrence of slight oxidation of B and BB during the shrouded plasma spray process. In addition, the batch 3 powders produced a mixture of m-ZrO₂ and ZrCₓO_{y}, a stoichiometric oxycarbide phase as a result of slight oxidation during the spray process. The topcoat exhibited the Sm_{0.11}Zr_{0.89}O_{1.95} phase, a non-transformable, non-equilibrium tetragonal t′—ZrO₂ phase, along with some m-ZrO₂ phases, which is believed to be cause by non-equilibrium rapid quenching of molten droplets at a rate of 10000° C./s during the plasma spray fabrication process.

EDS scans of cross-sections of the as-sprayed showed that each sublayer contained all expected elements. The ZBS and ZZC sublayers exhibited microcracks and pores as processing artifacts. The ZZC sublayer demonstrated some C-rich spots, indicating the presence of molten carbide ZrCₓ phases. The as-sprayed B coating demonstrated anchoring to the underlying SiC-coated C/C surface. The ZZC and ZBS sublayers exhibited good interfacial bonding in the cross-section of BB coating. All three sublayers in the BBB cross-sectional microstructure demonstrated good interfacial adhesion with each other. Sm₂O₃ phase could be seen to be segregated in the top Sm_{0.11}Zr_{0.89}O_{1.95} layer. The presence of Si and C as an element could be confirmed from EDS map scans of the cross-section. The ZZC sublayer contained Zr, C, and O elements, suggesting the presence of ZrC, ZrCₓ, ZrCₓO_{y}, and m-ZrO₂ phases in this sublayer.

Ablation tests were performed on bare C/C coupons as well as coated coupons, maintaining a constant heat flux of 400 W/cm² for 60 s. The bare C/C ablated at a rate of 2.61±0.09 mg/cm² s and lost 15.23% of its original mass. The B and BB-coated C/C successfully reduced ablation rates by about 84% (to about 0.41±0.29 mg/cm² s) and about 91% (to about 0.23±0.17 mg/cm² s), respectively, despite being oxidized. The oxidized white surfaces were primarily indexed as m-ZrO₂ in the XRD scans. Thus, both the B and BB coatings significantly reduced the ablation rate of the C/C, but their surfaces were oxidized entirely and formed primarily m-ZrO₂. The front surface temperature of B coating was initially less than that of both C/C and BB coating owing to ZBS's initial oxidation towards forming a borosilicate glass layer with a high IR emissivity. As this borosilicate glass layer evaporates, the emissivity decreases, causing the surface temperature to rise slightly. The ZZC surface of the BB coating exhibited a higher surface temperature, apparently due to the low intrinsic emissivity of ZrC.

Ablation testing showed that of all of the four-layer protective coating system combinations successfully survived the ablation tests without any major delamination or spallation and successfully protected the C/C substrate from oxidation and ablation. However, humps and protrusions were developed on A series 4-layer (AAA, AAB, and AAC) coatings. There were no ablation-induced protrusions on C series 4-layer (CCA, CCB, and CCC) coating surfaces, but they developed some pronounced surface cracks during the cooling period to room temperature. On the contrary, B series coatings neither developed protrusions nor pronounced cracks apart from BBC. The C/C without any coating protection ablated at a rate of about 2.61±0.09 mg/cm² s and lost about 15.23% of its original mass due to severe oxidation and ablation at high temperatures. The B and BB-coated C/C successfully reduced ablation rates by about 84% (to about 0.41±0.29 mg/cm² s) and about 91% (to about 0.23±0.17 mg/cm² s), respectively, despite being oxidized. Oxidized white surfaces were primarily indexed as m-ZrO₂ in the XRD scans. These tests showed that the B series coatings, specifically BBA and BBB, outperformed all other coatings. The ablated four-layer coatings demonstrated the presence of t′-ZrO₂ phases along with some m-ZrO₂ phases.

Ablation tests on bare C/C, AAA (representing A-series), BBB (representing B-series), and CCC (representing C-series) coatings showed that ablation rates decreased with increased coating thickness. Bare C/C lost about 70.75% of its original mass with a mass ablation rate of about 2.58 mg/cm² s after 300 s exposure to the ablation torch. The coated samples significantly reduced the mass loss rates and increased the ablation resistance of C/C. The mass loss and ablation rate decreased with increasing sublayer thickness. Although some protrusions developed on the surface, the BBB coating showed the best performance after ablation, as the coating remained intact during the cooling phase. On the contrary, the AAA coating completely peeled off the C/C, and the CCC surface partially exfoliated off the C/C.

The emittance of the Sm₂O₃—ZrO₂ was also tested. In order to maximize the outward heat transfer via radiative cooling, a high spectral emissivity (emittance), ideally that of a blackbody, is desirable. At elevated temperatures such as 1000° C. and above, the maximum thermal radiation occurs in the infrared spectral range of 1 to 14 μm according to Wein's displacement law. Experiments to measure the spectral emittance of the Sm₂O₃-modified ZrO₂, top coating material. The hemispherical spectral emittance of 6 mol % Sm₂O₃ stabilized ZrO₂ (Sm_{0.11}Zr_{0.89}O_{1.95}) at 900° C., 1000° C., 1100° C., and 1200° C. was measured. Emittance values were obtained for three consecutive measurements (about 30 s for each measurement) taken at the time when the temperature stabilized at the target temperature. In all twelve measurements, Sm_{0.11}Zr_{0.89}O_{1.95} demonstrated a very high spectral emittance of about 0.8 to 0.99 at the wavelength range of 7 to 15 μm with a peak at 12.5 μm. Such high spectral emittance is beneficial in hypersonic applications for transferring thermal energy from the leading-edge surface via radiation.

Tests have shown that the ablation of ZrB₂—SiC can be characterized in three stages. In the initial stage, when the front side temperature was below 1600° C., ZrB₂—SiC oxidized, and a continuous amorphous glass layer was formed in the heat-affected surface. The oxidation product B₂O₃ could volatilize above 1200° C., and ZrO₂ could precipitate out of the liquid phase to form skeletal structures in the sub-layer. In the second stage of ZrB₂—SiC ablation, the active oxidation of the SiC phase at a low O₂ partial pressure together with the volatilization of SiO₂ with increasing temperature can lead to consumption of the glass phase, leaving a very thin SiO₂ layer at the surface. During the final stage, when the surface temperature reached over 1800° C., the m-ZrO₂ could concentrate on the surface and form a thin continuous ZrO₂—SiO₂ layer that might resist ablation and oxidation of sublayer material. An unoxidized layer of ZrB₂—SiC adhered to the C/C surface, evidencing that a dense, continuous thin layer of ZrO₂ embedded with glass is able to prevent ablation and oxidation significantly. However, at elevated heat flux conditions (about 390 W/cm²), the ablation mechanism of the ZrB₂—SiC layer could change from chemical erosion to mechanical erosion, eventually leading to the loss of the thin ZrO₂—SiO₂ layer. To prevent such an erosion of the ZrB₂—SiC protective layer, the multi-layer protective coating system 22 applies a dense, Sm₂O₃-stabilized ZrO₂ layer 32 as a topcoat to prevent the inward diffusion of O₂ and lower the subsurface temperature through a combination of its higher emissivity and reduced thermal conductivity. However, because of the significant CTE mismatch between the ZrB₂—SiC layer 28 (about 6×10⁻⁶/m/° C.) and the ZrO₂-based top layer 32 (about 11×10⁻⁶/m/° C.), the ZrC—ZrO₂ composite (ZZC) is added as an intermediate third layer 30, which is intended to reduce the CTE mismatch and improve the oxidation resistance of the protective coating system 22. The layers prepared from ZrB₂—SiC and ZrC—ZrO₂ composites can increase the ablation resistance of C/C substrates, but these materials are prone to oxidation, limiting their application as protective materials in high heat flux oxidizing environments.

The Sm_{0.1}Zr_{0.89}O_{1.95} topcoat acts as a thermal and oxygen barrier layer so that the sublayers of the multilayer coating system 22 are protected while improving the ablation resistance of the C/C substrate. To test the topcoat, samples with nine different sub-layer thickness combinations were divided into the following categories according to the thickness of the ZrB₂—SiC and ZrC—ZrO₂ underlayers: A-series, B-series, and C-series (see Table 4). Coatings of each series had three variants depending on the topcoat thickness. All nine variants survived without spalling or exfoliation after being ablated for 60 s at about 390 W/cm² heat flux. However, the A-series coatings showed some protrusions on their surface. The B and C series coatings developed no such topological features. In terms of mass ablation rates and %-mass loss, the B-series coating seemingly performed better compared to the other two series. After 60 seconds of ablation, the AAA coating formed a porous ZrO₂ skeleton structure throughout the coating thickness. EDS point scans confirmed the formation of m-ZrO₂, which confirms the complete oxidation of the ZrC—ZrO₂ sublayer and the ZrB₂—SiC sublayer during the ablation experiment. Near the surface, a concentration of Sm element with about 44 wt % was identified. The as-sprayed Sm_{0.11}Zr_{0.89}O_{0.95} nominally contains about 15 wt % Sm, about 72 wt % Zr, and about 13 wt % O, which suggests that Sm was depleted from the bulk and formed Sm₂O₃-rich stabilized ZrO₂ near to the surface. The topcoat buckled locally as the gaseous oxidation products attempted to vent out, forming humps and protrusions. The fracture at the buckle's tip could originate from topcoat shrinkage during the post-ablation cooling stage. The ablation behavior of the AAB and AAC coatings appeared identical to AAA.

The thickness of the sublayers was found to be a factor in preventing the oxidation of the sublayers. The ablation tests showed that sublayer thicknesses of about 50 μm or less was not an ideal value. However, the four-layer coating performed significantly better when the sublayer thickness was increased to about 100 μm. The ablation rate of C/C was reduced by 91% with the help of these coatings. In particular, no protrusions or pronounced surface cracks appeared in the BBA and BBB coatings. The B-series coating demonstrated almost identical cross-sectional architecture post-60 s ablation experiment at about 390 W/cm². The cross-sectional architecture included a densified topcoat, ZrCₓO_{y}—ZrO₂ transition layer, unoxidized ZrB₂—SiC layer, and unoxidized C/C. All three B variants demonstrated a uniform densified topcoat, a slightly oxidized ZrC—ZrO₂ sublayer, and an unoxidized ZrB₂—SiC sublayer. The topcoat of BBA and BBB looked almost identical and demonstrated no significant crack developments other than some interlaminar porosity and microcracks less than 10 μm in length. The topcoat of BBC coating showed laminar porosity as well as some major cracks extending from the topcoat surface to the bulk. The ZrC—ZrO₂ layer of these three B variants exhibited some delamination crack growth at the laminar and layer-layer interface. While ZrC—ZrO₂ in BBA and BBB had some interfacial delamination up to 200 μm long, the one in BBC coating eventually caused layer-layer separation with the ZrB₂—SiC sublayer. The ZrB₂—SiC sublayer remained unoxidized in all three B variants and adhered to the C/C interface. Although the ZrB₂—SiC sublayer did not develop any interfacial crack with C/C, there were some vertical penetrating cracks causing a split within the layer owing to the release of residual stress. The presence of expected elements such as Zr, B, Si, and C in ZrB₂—SiC sublayers was confirmed via EDS. Thus, it is seen that a sublayer thickness of about 100 μm improved the ablation and oxidation resistance of the coating system and C/C substrate. However, when the sublayer thickness was increased to 150 μm, as with C-series coatings (see Table 4), the ablation rates and % mass loss after 60 s torch exposure increased, implying their inferior performance compared to the B-series coatings. The cross-sections of the CCC coatings showed that the dense topcoat developed some surface-to-bulk major cracks. These cracks merged with some penetrating cracks and extended vertically through all sublayers to C/C. The tips of such surface-to-bulk cracks were 50-100 μm wide and could be visually identified from the top as pronounced cracks.

Long-term ablation performance was investigated for the BBB coating, which was ablated for 300 s at about 390 W/cm². EDS point scan results showed that the coating system contained mostly oxide scales, which indicate that the oxidation of ZrC—ZrO₂ and ZrB₂—SiC sublayers was set off after a certain period when the cracks and pores acted as oxygen diffusion channels. Despite the oxidation of the coating sublayers, the C/C interface beneath ZrB₂—SiC and pack cemented SiC layers appeared unaffected and intact even after 300 s of aggressive ablation.

In addition, investigations were conducted regarding the role of Sm₂O₃ stabilized ZrO₂ in resisting ablation and oxidation of C/C without any intermediate protective layers between the Sm₂O₃ stabilized ZrO₂ and the SiC layer on the C/C substrate. Layers of stabilized ZrO₂ were synthesized using atmospheric plasma spray and tested at a high heat flux (about 390 W/cm²) oxyacetylene torch ablation rig. For comparison, Y₂O₃, another sesquioxide, was selected as a stabilizer for other test specimens but not as an emissivity modifier, which has a similar lattice structure to Sm₂O₃. The ablation resistance of the commercially available Y₂O₃ stabilized ZrO₂ coating was compared to that of a Sm₂O₃ stabilized ZrO₂ layer of the present disclosure by analyzing the microstructural evolution and phase development of the coatings before and after the ablation test. In addition, the ablation resistance and thermal stability of both tetragonal and cubic polymorphs of ZrO₂ were compared.

Before applying any coatings the surface of the C/C composite substrate was pre-treated by abrasion with a fine sandpaper and an oxyacetylene flame to increase the surface roughness and, therefore, to create geometric textures referred to as anchors. Next, a layer of SiC was applied to the abraded substrate surface by a pack cementation process. Then, The Sm₂O₃-stabilized ZrO₂ layer was applied to the SiC-coated, C/C composite substrate using atmospheric plasma spray.

In the process of “anchoring,” pre-ablation of the substrate surface was used as a means to increase the surface roughness of the C/C substrate at a controlled rate, thereby forming anchors for the protective coating system so that the mechanical adhesion between the coating and the substrate can be improved. In this experiment, the anchors were in the form of groove features (“anchoring channels”) which resulted in improved penetration of SiC inside the C/C bulk. These anchoring channels retained the pack-cemented SiC layer through an interlock mechanism. Despite a significant thermal expansion coefficient mismatch between the substrate and the protective coating system, a well-defined mechanical adhesion characterized by the anchors was observed in pre- and post-ablated coating systems, indicating its influence in improving ablation resistance.

More particularly, for these investigations, C/C composite specimens with density 1.47 g/cm³ were used as substrates. First, the C/C surface was prepared for pack cementation by first abrading with 320 grit SiC paper and then pre-ablating for approximately 30-45 seconds with an oxy-fuel ablation torch. In this process, the surface roughness of C/C was increased from Sₐ=11.93 μm to 21.64 μm. Later, the pre-ablated samples were washed in an ultrasonic bath for about 5 minutes sequentially using deionized water and ethanol as solvents. The washed samples were then dried in an oven for about two hours at 135° C. Next, to minimize the significant CTE mismatch between C/C and zirconia mismatch, a thin interlocking transition layer of SiC (CTE about 4-5×10⁻⁶/m/K) was applied to the C/C surface via pack cementation. In this pack cementation process, 60 wt % Si powder, 25 wt % graphite, and 15 wt % alumina were mixed in a container and ball milled for over 4 hours to form a powder mixture. The C/C substrates were embedded in the powder mixture and placed in a graphite crucible for heat treatment. The heat treatment was carried out at 1900° C. for two hours in Ar within a graphite furnace. During this pack cementation process, the Si reacts with graphite and forms SiC, while Al₂O₃ acts as an activator and densifies the SiC layer. To prepare powder feedstock for plasma spray, Sm₂O₃ and ZrO₂ powders were mixed and spray dried in two separate batches with a third batch of conventional yttrium-based powder for comparison. The first batch (“batch 1”) was made of 6 mol % (15.3 wt %) Sm₂O₃ and 94 mol % ZrO₂. The second batch (“batch 2”) was made of 11 mol % Sm₂O₃ (26 wt %) and 89 mol % ZrO₂. The powders were mixed in a slurry with an approximately 50:50 solid-to-liquid ratio using 0.15 wt % Darvan 821A as the dispersant and 2 wt % PVA as the binder. The binder was allowed to dissolve completely before adding the ceramic powder. The slurries were further diluted to 32-35% solid to achieve optimum viscosity that would allow effective atomization. For comparison, the third batch (batch 3) was made with commercially-graded plasma-sprayable 12 mol % Y₂O₃ and 88 mol % ZrO₂ powder. The granulated powders were deposited as layers on the SiC-coated C/C substrate using atmospheric plasma spray technology. The plasma sprayed layers from batch 1, batch 2, and batch 3 powders are referred to as 6SZC, 11SZC, and 12YZC, respectively, in the following discussion.

To test the samples, an oxyacetylene ablation torch rig was used to evaluate the ablation properties of bare C/C substrates and the three plasma-sprayed layers on C/C substrates and ablation rates for each sample were obtained. XRD patterns of the as-sprayed layers showed that all three batches of powders formed partially stabilized zirconia phases upon plasma spraying. However, the batch 1 powders were stabilized into a non-transformable tetragonal (t′) phase, whereas batch 2 and batch 3 powders were stabilized into a cubic (c) phase. The non-transformable t′ phase is a non-equilibrium phase that differs from the regular metastable tetragonal (t) phase because of its smaller tetragonality (c/a ratio). Despite a large difference in their thermal expansion coefficients, the three stabilized ZrO₂ layers (batches 1, 2, and 3) showed a well-defined mechanical bond with the substrate and did not delaminate after rapid quenching of the droplets and rapid solidification of the lamellae. Sm₂O₃ phase segregation was observed when examining the cross-section of as-sprayed 6SZC and 11SZC. The presence of pack-cemented thin SiC layers in as-sprayed coatings was confirmed from EDS scans of cross-sectional micrographs. The ablation rates of the coatings were compared with that of the C/C substrate without any coating. The 6SZC sample successfully reduced the specific mass ablation rate of C/C by about 71% (from 1.92 mg/cm² s to 0.55 mg/cm² s) and the linear ablation rate by about 94% (from 12.13 μm/s to 0.67 μm/s). Furthermore, after two cycles of 60 s high heat flux exposure at about 390 W/cm², the 6SZC sample successfully survived without spalling off the substrate. In contrast, although the other coatings reduced the ablation rates significantly, 11SZC denuded off the substrate, and 12YZC melted near the central area of the hot zone. In addition, the surface temperature near the hot zone of 6SZC was noticeably lower than both 11SZC and 12YZC during the first heating cycle. Front surface temperature measured during ablation tests showed that, in steady state conditions, the 6SZC samples reduced the front surface temperature by about 450° C., about a 24% drop, due to the expected higher emittance of Sm₂O₃-modified ZrO₂. XRD patterns of the 6SZC and 11SZC samples after 60 s ablation showed that, after the first cycle of ablation, m-ZrO₂ peaks disappeared in both coatings, implying a monoclinic to tetragonal phase transformation during high heat flux testing. The reduced surface temperature of 6SZC during the ablation test can be explained by the improved ability of Sm₂O₃ to radiate heat at high temperatures, which is characterized by the high emissivity (emittance) of Sm₂O₃. It is believed that, during ablation testing, the segregated Sm₂O₃ particles in 6SZC microstructure may have been thermally activated and diffused into the m-ZrO₂ grains leading to their stabilization in the t′-ZrO₂ phase. Despite the large CTE mismatch, the 6SZC was prevented from spalling due to the anchors on the C/C surface. In fact, modeling simulations showed that the CTE mismatch was beneficial in this phenomenon. The 6SZC specimen, with its anchoring properties, solved the problem of interfacial delamination of t-ZrO₂ coating from the C/C surface, apparently by shifting the location of these cracks up into the coating as interlaminar cracks. Similar tests were made to the 11SZC and 12YZC specimens. Out of three plasma sprayed coatings, 6SZC successfully endured multiple cycles of 60 s high heat flux (about 390 W/cm²) ablation testing without exfoliation. 6SZC increased the ablation resistance of C/C composites by reducing the mass ablation of C/C in an oxidizing environment. On the contrary, cubic phase coatings, the 11SZC and 12YZC specimens, failed to survive in the first cycles of tests due to their poor performance in reducing the surface temperature and resisting thermal shock. As such, it was concluded that the cubic phase of ZrO₂ is preferably avoided in the fourth layer 32, for example, a maximum content of about 10 mol % Sm₂O₃, more preferably a maximum content of about 6 mol % Sm₂O₃ (6SZC), in the Sm₂O₃—ZrO₂ fourth layer 32. On the other hand, it was concluded that the fourth layer 32 should contain at least 2.5 mol % Sm₂O₃ in the Sm₂O₃—ZrO₂ to obtain the beneficial effects of Sm₂O₃ observed in the investigations, in particular, a tough phase-stable coating with the requisite emittance.

From this, it can be seen that the non-equilibrium tetragonal (1′) ZrO₂ protective coating system stabilized with 6 mol % Sm₂O₃ offered the best ablation resistance, with survivability maintained through 120 seconds of about 390 W/cm² heat flux oxyacetylene ablation heating without any denudation from the C/C substrate. The protective coating system significantly improved the ablation resistance of the C/C, reducing the mass ablation rate by about 71% and the linear ablation rate by about 94%. Sm₂O₃ was used to stabilize the ZrO₂ in a tetragonal phase. Due to the rapid quenching of ZrO₂ particles during the plasma spray process, 6 mol % Sm₂O₃ stabilized ZrO₂ yielded a non-equilibrium tetragonal (t′) phase, which did not undergo the deleterious t-m martensitic transformation upon cooling. Advantageously, Sm₂O₃, a sesquioxide, has a high intrinsic emissivity and can therefore be used as an emissivity modifier of the host material, in this case, ZrO₂. A high emissivity, with a value close to that of a black body (ε=1), may be advantageous to reduce the surface temperature of the control surfaces of hypersonic flight during atmospheric re-entry. A reduced surface temperature can be beneficial in preventing surface ablation and oxidation of virgin material.

In summary, the test coatings with sublayer thicknesses of about 100 μm (regarded as B-series coatings in Table 4) demonstrated excellent ablation, oxidation, and mass erosion resistance as they reduced the mass ablation rate of C/C by 90% with a maximum surface temperature of about 2100° C. The B-series coatings developed a dense topcoat that effectively acted as a barrier to heat and oxygen. The UHTC-based sublayers of this coating system remained physically and chemically unaffected and maintained their integrity during the high heat flux ablation testing period. The Sm_{0.11}Zr_{0.89}O_{1.95} of the topcoat layer had a very high emittance at a spectral range of 7.5 to 15 μm with a peak (ε=0.99) at 12.5 μm, which was beneficial in radiating energy and cooling the surface at elevated temperatures. Overall, a thickness-optimized multilayer coating system 22 with a Sm₂O₃-stabilized ZrO₂ topcoat 32 and UHTC-based sublayers 26, 28, and 30 can be an effective and practical solution to the ablation and oxidation problem of C/C substrates, as the coating system 22 successfully protected the C/C substrate 24 up to 2100° C. without any surface damage or exfoliation.

As previously noted above, though the foregoing detailed description describes certain aspects of one or more particular embodiments of the invention, alternatives could be adopted by one skilled in the art. For example, the multi-layer protective coating systems and is their components could differ in appearance and construction from the embodiments described herein and shown in the drawings, functions of certain components of the multi-layer protective coating systems could be performed by components of different construction but capable of a similar (though not necessarily equivalent) function, and various materials could be used in the fabrication of the multi-layer protective coating systems and/or their components. As such, and again as was previously noted, it should be understood that the invention is not necessarily limited to any particular embodiment described herein or illustrated in the drawings.

1. A multi-layer protective coating system for a substrate comprising,
a first layer comprising silicon carbide (SiC) disposed on a substrate to be protected;
a second layer comprising zirconium diboride-silicon carbide (ZrB₂—SiC), the second layer disposed on and in contact with the first layer;
a third layer comprising zirconium carbide-zirconium oxide (ZrC—ZrO₂), the third layer disposed on and in contact with the second layer; and
a fourth layer comprising samaria-modified zirconium oxide (Sm₂O₃—ZrO₂), the fourth layer disposed on and in contact with the third layer.

2. The multi-layer protective coating system of claim 1, wherein the samaria-modified zirconium oxide (Sm₂O₃—ZrO₂) layer has spectral emittance in a range of 0.8 to 0.99 at radiation wavelength in a wavelength range of 7 μm to 15 μm.

3. The multi-layer protective coating system of claim 1, wherein the fourth layer is the outermost layer of the multi-layer protective coating system opposite the substrate.

4. The multi-layer protective coating system of claim 1, wherein the samaria-modified zirconium oxide (Sm₂O₃—ZrO₂) comprises non-equilibrium tetragonal (t′) ZrO₂ stabilized with Sm₂O₃.

5. The multi-layer protective coating system of claim 1, wherein the substrate is a carbon-fiber reinforced carbon matrix (C/C) composite.

6. The multi-layer protective coating system of claim 1, wherein multi-layer protective coating system consists of the first, second, third and fourth layers, the first layer consists of silicon carbide (SiC), the second layer consists of zirconium diboride-silicon carbide (ZrB₂—SiC), the third layer consists of zirconium carbide-zirconium oxide (ZrC—ZrO₂), and the fourth layer consists of samaria-modified zirconium oxide (Sm₂O₃—ZrO₂).

7. An article of manufacture comprising:
a substrate made of carbon-fiber reinforced carbon matrix (C/C) composite; and
a multi-layer protective coating system disposed on a surface of the substrate, the protective coating system comprising:
a first layer containing silicon carbide (SiC) disposed on a surface of the substate;
a second layer comprising zirconium diboride-silicon carbide (ZrB₂—SiC), the second layer disposed on a surface of the first layer;
a third layer comprising zirconium carbide-zirconium oxide (ZrC—ZrO₂), the third layer disposed on a surface the second layer; and
a fourth layer comprising samaria-modified zirconium oxide (Sm₂O₃—ZrO₂), the fourth layer disposed on a surface of the third layer.

8. The article of manufacture of claim 7, wherein the substrate is part of a hypersonic aeronautical vehicle.

9. The article of manufacture of claim 8, wherein the substrate is located at a leading edge of the hypersonic aeronautical vehicle subject to temperatures above 1200° C. during flight through earth atmosphere.

10. The article of manufacture of claim 9, wherein the hypersonic aeronautical vehicle is a hypersonic aircraft.

11. The article of manufacture of claim 9, wherein the leading edge is disposed at any one of a wing, a stabilizer, a nose, a fuselage, and an engine of the hypersonic aeronautical vehicle.

12. A method of making a multi-layer protective coating system on a substrate to be protected, the method comprising:
providing the substrate with a first layer of the multi-layer protective coating system comprising silicon carbide (SiC) on an exterior surface of the substrate;
applying a second layer of the multi-layer protective coating system containing zirconium diboride-silicon carbide (ZrB₂—SiC) on and in contact with the first layer;
applying a third layer of the multi-layer protective coating system containing zirconium carbide-zirconium oxide (ZrC—ZrO₂) on and in contact with the second layer; and
applying a fourth layer of the multi-layer protective coating system containing samaria-modified zirconium oxide (Sm₂O₃—ZrO₂) on and in contact with the third layer.

13. The method of claim 12, wherein the second layer is applied by a first shrouded plasma spray process.

14. The method of claim 12, wherein the third layer is applied by a second shrouded plasma spray process.

15. The method of claim 12, wherein the fourth layer is applied by a plasma spray process.

16. The method of claim 12, wherein the second layer is applied by a first shrouded plasma spray process, the third layer is applied by a second shrouded plasma spray process, and the fourth layer is applied by a plasma spray process.

17. The method of claim 12, wherein the step of providing includes applying the first layer to the surface of the substrate.

18. The method of claim 17, wherein the first layer is applied by a pack cementation process.

19. The method of claim 17, further comprising roughening the surface of the substrate prior to applying the first layer to form anchors for mechanical adhesion of the first layer to the surface of the substrate.

20. The method of claim 19, wherein the step of roughening comprises abrading the surface and then ablating the surface.
